(19) United States
(12) Patent Application Publication
(10) Pub. No.: US 2022/0336120 A1
(43) Pub. Date: Oct. 20, 2022

(54) CONDUCTIVE MATERIAL, METHOD FOR MANUFACTURING THE SAME, AND ELECTRONIC DEVICE

(71) Applicant: Beijing Dream Ink Technologies Co., Ltd., Beijing (CN)

(72) Inventor: Shijin Dong, Beijing (CN)

(21) Appl. No.: 17/622,692

(22) PCT Filed: Aug. 3, 2020
(86) PCT No.: PCT/CN2020/106642

§ 371 Date: Dec. 23, 2021

(30) Foreign Application Priority Data
Aug. 6, 2019 (CN) CN201910722510.2

(51) Int. Cl. H01B 1/22; H01B 13/00; C08G 63/00; C08K 3/08; C08K 3/105

(52) U.S. Cl. CPC H01B 1/22; H01B 13/00; C08G 63/00; C08K 3/08; C08K 3/105; C08K 2003/0806

(57) ABSTRACT

The present disclosure provides a conductive material, a method for manufacturing the conductive material and an electronic device, and relates to the technical field of new materials. The conductive material provided by the present disclosure includes: a first component and a second component. The first component includes a liquid metal having a melting point below room temperature, a coating material, and a first solvent. The coating material coats liquid metal droplets formed by the liquid metal. The second component includes a base resin and a conductive powder. The first component and the second component are weighed in proportion, and are uniformly mixed to obtain the conductive material. The technical solution of the present disclosure can obtain a wire having better flexibility.

### CROSS-REFERENCE TO RELATED APPLICATIONS

The present application claims priority to Chinese Patent Application No. 201910722510. 2, titled with “conductive material, method for manufacturing the same, and electronic device” and filed on Aug. 6, 2019, the content of which is incorporated herein by reference in its entirety.

### TECHNICAL FIELD

The present disclosure relates to the field of new materials, and, particularly, relates to a conductive material, a method for manufacturing the conductive material, and an electronic device.

### BACKGROUND

In recent years, with rapid development of electronic information technology, the market has become increasingly demanding on the specificity and functionality of conductive materials. In order to meet the above requirements, the conductive material has gradually developed from a single material, such as metal and carbon, to a composite conductive material. The composite conductive material is mostly made of solid conductive media and carrier materials. For example, it is composited by combining conductive particles such as silver powder, copper powder, carbon powder, graphene, etc. with an epoxy resin, an acrylic resin, a polyurethane resin, a vinyl chloride-vinyl acetate copolymer resin, and a silicone resin.

The applicant found that such a composite conductive material is generally difficult to have good bending resistance and tensile resistance, therefore it cannot meet requirements for high flexibility (such as, bending resistance, tensile resistance, distortion resistance) of flexible electronic products after the conductive material is formed.

### SUMMARY

### BRIEF DESCRIPTION OF DRAWINGS

The present disclosure provides a conductive material, a method for manufacturing the conductive material, and an electronic device, which can cause a wire to have better flexibility.

In a first aspect of the present disclosure, a conductive material is provided, which adopts following technical solutions.

The conductive material includes:

a first component having a liquid metal with a melting point below room temperature, a coating material coating a liquid metal droplet formed by the liquid metal, and a first solvent; and

a second component including a base resin and a conductive powder;

in which the first component and the second component are weighed in proportion and uniformly mixed to obtain the conductive material.

Optionally, the first component includes 30% to 99% by weight of the liquid metal, 0.1% to 30% by weight of the coating material, and 0.9% to 50% by weight of the first solvent.

Optionally, the first component includes 75% to 99% by weight of the liquid metal, 1% to 5% by weight of the coating material, and 3% to 20% by weight of the first solvent.

Optionally, a weight ratio of the first solvent to the coating material is in a range of 1:2 to 1:5.

Optionally, the liquid metal includes at least one of gallium, gallium indium alloy, gallium tin alloy, gallium indium tin alloy, or gallium indium tin zinc alloy.

Optionally, the liquid metal droplet has a diameter ranging from 0.01 μm to 100 μm.

Optionally, the liquid metal droplet has a diameter ranging from 0.05 μm to 10 μm.

Optionally, the coating material includes one or more of polyester resin, melamine resin, chlorine vinegar resin, vinyl chloride-vinyl acetate resin, silicone resin, gelatin, sodium alginate, polyvinyl pyrrolidone, chitosan, polyurethane resin, polyacrylic resin, vinyl chloride-vinyl acetate resin, epoxy resin, fluorocarbon resin, epoxy acrylic resin, epoxy acrylate resin, polyester acrylate resin, phenolic resin, nitrocellulose, ethyl cellulose, alkyd resin, and amino resin.

Optionally, the first solvent includes one or more of water, ethyl acetate, butyl acetate, isoamyl acetate, n-butyl glycolate, petroleum ether, acetone, butanone , cyclohexanone, methyl isobutyl ketone, diisobutyl ketone, toluene, xylene, butyl carbitol, alcohol ester 12, DBE, ethylene glycol butyl ether, ethylene glycol ethyl ether, dipropylene glycol methyl ether, n-hexane, cyclohexane, n-heptane, n-octane, or isooctane.

Optionally, the first component further includes a deformer.

Optionally, in the second component, the weight content of the base resin is in a range of 10% to 40%, and the weight content of the conductive powder is in a range of 20% to 90%.

Optionally, the second component further includes one or more of a second solvent or an auxiliary agent.

Optionally, the base resin includes one or more of polyester resin, polyurethane resin, polyacrylic resin, vinyl chloride-vinyl acetate resin, epoxy resin, epoxy acrylic resin, epoxy acrylate resin, polyester acrylate resin, phenolic resin, nitrocellulose, ethyl cellulose, alkyd resin or amino resin.

Optionally, the conductive powder includes one or more of silver powder, copper powder, carbon black, graphite, graphene, carbon nanotube, silver-coated copper powder, iron powder, or iron-nickel powder.

Optionally, the weight ratio of the first component to the second component is in a range of 10:1 to 1:9.

Optionally, the conductive material further includes a viscosity modifier added after the first component and the second component are mixed.

In a second aspect of the present disclosure, a method for manufacturing the above conductive material is provided, which adopts following technical solutions.

The method for manufacturing a conductive material includes:

S1: manufacturing a first component, wherein the first component includes a liquid metal having a melting point below room temperature, a coating material and a first solvent, and the coating material coats liquid metal droplets formed by the liquid metal;

S2: manufacturing a second component, wherein the second component includes a base resin and a conductive powder; and

S3: weighing the first component and the second component in proportion, and mixing the first component and the second component uniformly to obtain the conductive material.

Optionally, the S1 includes:

S11: dissolving the coating material with the first solvent so as to form a coating material solution;

S12: weighing the coating material solution and the liquid metal in proportion, and putting the coating material solution and the liquid metal into a closed container;

S13: filling a protective gas and mixing the coating material solution and the liquid metal; and

S14: obtaining the first component after the mixing is completed.

Optionally, the S2 includes:

S21: dissolving the base resin into a resin solution by using the second solvent;

S22: weighing the resin solution and the auxiliary agent in proportion, and adding the auxiliary agent to the resin solution;

S23: weighing the conductive powder, and put it into a closed container together with the material obtained in S22;

S24: pre-dispersing the material obtained in S23 by using a mixer;

S25: processing the material obtained in S24 by using a three-axis rolling mill;

S26: defoaming the material obtained in S25 to obtain the second component.

Optionally, the S3 includes:

S31: weighing the first component and the second component in proportion, and adding the first component and the second component to a container;

S32: stirring the first component and the second component uniformly to obtain a mixture;

S33: measuring a viscosity of the mixture obtained from S32 to compare the viscosity with a preset viscosity range, wherein if the viscosity is within the preset viscosity range, the mixture obtained from S33 is the conductive material, and if the viscosity is higher than the preset viscosity range, a S34 will be performed; and

S34: adding a viscosity modifier to adjust the viscosity of the mixture obtained from S32 to be within the preset viscosity range, so as to obtain the conductive material.

In a third aspect of the present disclosure, an electronic device is provided. The electronic device includes a wire, in which the wire is made of a conductive material according to any one of the above items.

The present disclosure provides a conductive material, a method for manufacturing the conductive material and an electronic device. The conductive material includes: a first component and a second component. The first component includes a liquid metal having a melting point below room temperature, a coating material, and a first solvent. The coating material coats liquid metal droplets formed by the liquid metal. The second component includes a base resin and conductive powder. During use of the wire made of the above conductive material, when the wire is bent, stretched or twisted, the coating material is deformed to rupture, the coated liquid metal is released. The above liquid metal is in a liquid state at room temperature, such that it has better fluidity and deformability. The liquid metal can fill a conductive path, such that the wire has better flexibility.

### DESCRIPTION OF EMBODIMENTS

In order to more clearly illustrate objects, technical solutions and advantages of embodiments of the present disclosure, the technical solutions in some embodiments of the present disclosure are clearly and completely described below with reference to the accompanying drawings in some embodiments of the present disclosure. The described embodiments are merely part of the embodiments of the present disclosure rather than all of the embodiments. All other embodiments obtained by a person skilled in the art shall fall into the scope of the present disclosure.

It should be noted that various technical features in embodiments of the present disclosure can be combined with one another if there is no conflict.

A first aspect of the present disclosure provides a conductive material. The conductive material includes a first component and a second component. The first component includes a liquid metal with a melting point below room temperature, a coating material and a first solvent. The coating material coats liquid metal droplets formed by the liquid metal. The second component includes a base resin and a conductive powder. The first component and the second component are weighed in proportion and uniformly mixed to obtain the conductive material.

During use of the wire made of the above conductive material, when the wire is bent, stretched or twisted, the coating material is deformed to cause a rupture, the coated liquid metal is released. The above liquid metal is in a liquid state at room temperature, such that it has better fluidity and deformability. The liquid metal can fill a conductive path, such that the wire has better flexibility.

In addition, since the liquid metal has a high conductivity greater than 1*10⁶ S/m, the above conductive material can have better electrical properties, e.g., the highest conductivity can reach 1*10⁷ S/m, which can improve 5 to 10 times than that of the similar products.

In some embodiments of the present disclosure, the conductive materials can be applied to molding processes such as screen printing, flexographic printing, transfer printing, extrusion dispensing, and stencil printing, and can be cured by heating after molding. In some embodiments of the present disclosure, the liquid metal of the conductive material is in a form of uniformly dispersed sub-micron or even nano-sized droplets before printing, and doesn't cause phase separation or metal overflow phenomenon during the printing process.

In some embodiments of the present disclosure, the conductive materials can be printed on various non-metallic substrates such as PET, PVC, PI, PMMA, PC, ABS, PE, PP, and the like, which can meet functional requirements of conductive materials in different fields of modern industry.

It should be noted that in the present disclosure, the expression “room temperature” is also referred to as normal temperature or general temperature, and is generally defined as 25 centigrade degree. Therefore, the expression “below room temperature” means a temperature lower than 25° C.

Although some related arts disclose that liquid metal and various conductive powders are filled into a resin system so as to manufacture a curable composite conductive material, the applicant has found that, as shown in FIG. 1, FIG. 1 is an optical micrograph showing a composite conductive material in the related art, the agglomeration, flocculation, sedimentation and other phenomena of the conductive powder are serious in the composite conductive material, such that fineness is significantly decreased, conductive materials are unevenly distributed, resulting in a significant increase in electrical resistance or even complete non-conductivity.

The above composite conductive material can be manufactured by one of the following three methods. In a first method, the liquid metal and the conductive powder are filled into a resin system. In a second method, the conductive powder is firstly added to the resin system, and a liquid metal is then added. In a third method, conductive powders are added in the resin system, and a liquid metal is added in another solvent system to mix.

After a large number of repeated experiments and analyses on the components and manufacturing process of the above composite conductive material, the applicant found that the reasons for the above phenomenon are as follows. During the manufacturing process of the composite conductive material, the liquid metal undergoes various “high-energy” processing processes (e.g., stirring, ball milling, sand milling, three-roll milling, etc.) to have a significant wetting and coating effect for the conductive powder. With the wetting and coating of the liquid metal taking effect, the conductive powders will collide with each other during the high-speed movement to quickly fuse, and/or, the liquid metal changes the original spreading state of the wetting dispersant in the resin system in the solvent and resin, such that the resin is rapidly changed in morphology and is flocculated into units with extremely small surface area. Therefore, conductive powders cannot be provided with physical barrier and a stable double layer structure, which cause the conductive powders to agglomerate. The probability of the agglomeration situation increases significantly with the increase of the filling amount of liquid metal and a conductive powder. If the filling amounts of conductive powder and liquid metal are reduced, such a phenomenon can be avoided to a certain extent, but it causes a decrease in the content of effective components in the composite conductive material and a decrease in the overall conductivity.

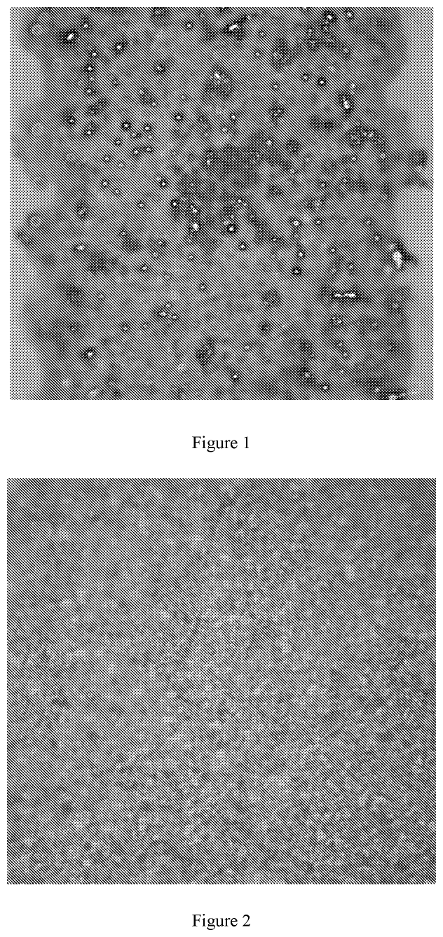

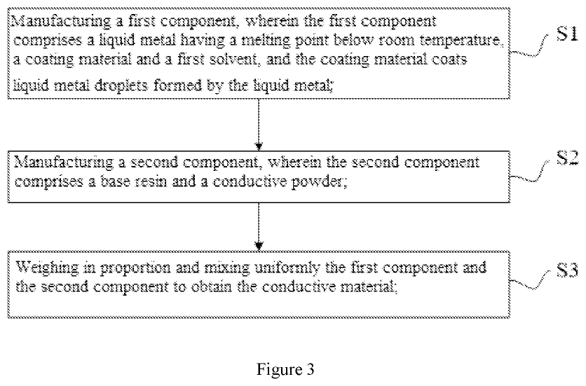

FIG. 2 is an optical micrograph showing a conductive material according to an embodiment of the present disclosure. As shown in FIG. 2, in some embodiments of the present disclosure, the conductive material has high fineness, uniform distribution, and low resistance. The reasons are as follows: the liquid metal in the conductive material of the embodiments of the present disclosure is in the first component, and the conductive powders are in the second component. In the high-energy process of manufacturing the first component or the second component, the liquid metal will not contact with the conductive powders. If it is required to use conductive materials, when the first component and the second component are mixed, the mixing process does not require high energy, and the liquid metal is coated in the coating material, that is, the compounding process does not have strong physical and chemical actions, therefore, there is no interaction among liquid metal, conductive powders and resin in the related art.

The details of the first component, the second component and the conductive material composed of the first component and the second component are to be described below.

In some embodiments of the present disclosure, the first component includes 30% to 99% by weight of the liquid metal, 0.1% to 30% by weight of the coating material, and 0.9% to 50% by weight of the first solvent. For example, the weight content of liquid metal in the first component is 30%, 40%, 50%, 60%, 70%, 80%, 90%, 91%, 92%, 93%, 94%, 95% , 96%, 97%, 98% or 99%. The weight content of the coating material in the first component is 0.1%, 0.5%, 1.0%, 1.5%, 2.0%, 2.5%, 3.0%, 3.5% , 4.0%, 4.5%, 5.0%, 8%, 10%, 15%, 20%, 25% or 30%. The weight content of the first solvent in the first component is 0.9%, 1.0%, 2.0%, 3.0%, 4.0%, 5.0%, 6.0%, 7.0%, 8.0%, 10%, 15%, 20%, 30%, 40% or 50%.

Further, if the content of the liquid metal in the first component is excessively low, and the content of the coating material in the first component is excessively high, the coating material, as a non-conductive material will reduce the content of the conductive component in effect, which will reduce the content of the effective material in the conductive material. It is difficult to ensure the connection of the conductive particles after they are heated and cured, such that the overall resistance is increased significantly. If the content of the liquid metal in the first component is excessively high, and the content of the coating material in the first component is excessively low, the coating material is difficult to cover all the liquid metal, and the molecules of the coating material are not enough to spread on the surface of the liquid metal droplet in a single layer, such that the coating rate is low and the liquid metal is easy to leak and even fuse to coalesce. Based on the above, in some embodiments of the present disclosure, the first component can be further selected to include 75% to 99% by weight of the liquid metal, 1% to 5% by weight of the coating material, and 3% to 20% by weight of the first solvent.

In addition, the applicant found that a ratio of the first solvent to the coating material determines the viscosity of the coating material solution formed by the first solvent and the coating material. When the adding amount of the first solvent is excessively low, the viscosity of the coating material solution is excessively high, such that the coating material solution having no sufficient fluidity, which is difficult to evenly diffuse to the surface of the liquid metal droplets. When the adding amount of the first solvent is excessively high, the initial viscosity of the coating material solution is excessively low, such that a structure formed after the coating material coats the liquid metal droplets is poor, and the barrier ability of the coating material to adjacent liquid metal is not enough. Therefore, during a standing process or a using process, the liquid metal droplets are liable to re-assemble and fuse. Based on this, in some embodiments of the present disclosure, the weight ratio of the first solvent to the coating material is selected to be in a range of 1:2 to 1:5, e.g., 1:3 or 1:4.

In some embodiments of the present disclosure, the liquid metal in the first component is an elementary substance or an alloy that are liquid at room temperature, e.g., elementary gallium, gallium indium alloy, gallium tin alloy, gallium indium tin alloy, gallium indium tin zinc alloy, and the like.

In some embodiments of the present disclosure, the liquid metal droplets in the first component have a diameter ranging from 0.01 μm to 100 μm, e.g., 0.05 μm to 10 μm. On the one hand, it can avoid a poor performance stability of the first component, since the liquid metal droplets having excessively large diameter are easily polymerized. On the other hand, it can avoid a low efficiency of manufacturing the first component, since the diameter of the liquid metal droplets is excessively small to be excessively dispersed.

In some embodiments of the present disclosure, the coating material in the first component includes one or more of polyester resin, melamine resin, chlorine vinegar resin, vinyl chloride-vinyl acetate resin, silicone resin, gelatin, sodium alginate, polyvinyl pyrrolidone, chitosan, polyurethane resin, polyacrylic resin, vinyl chloride-vinyl acetate resin, epoxy resin, fluorocarbon resin, epoxy acrylic resin, epoxy acrylate resin, polyester acrylate resin, phenolic resin, nitrocellulose, ethyl cellulose, alkyd resin, and amino resin. Following advantages can be obtained by selecting the above coating materials. Firstly, the above coating materials can exist stably with liquid metal for a long time, and has a pH close to neutral without strong alkaline or acidic components, and may not have a significant chemical reaction with liquid metal. Secondly, the above coating material has good compatibility with the base resin of the second component, such that the conductive material has good fusion and no significant phase separation. Thirdly, the above coating materials have self-film-forming property, such that the overall performance of conductive materials is not affected.

In some embodiments of the present disclosure, the first solvent in the first component is one or more of water, ethyl acetate, butyl acetate, isoamyl acetate, n-butyl glycolate, petroleum ether, acetone, butanone , cyclohexanone, methyl isobutyl ketone, diisobutyl ketone, toluene, xylene, butyl carbitol, alcohol ester 12, DBE (dibasic ester), ethylene glycol butyl ether, ethylene glycol ethyl ether, dipropylene glycol methyl ether, n-hexane, cyclohexane, n-heptane, n-octane, or isooctane.

In addition, according to actual requirements, 0% to 2% by weight of a deformer can be added to the first component. The deformer can be mineral oil deformer or silicone deformer.

In some embodiments of the present disclosure, the weight content of the base resin in the second component is in a range of 10% to 40%, and the weight content of the conductive powder is in a range of 20% to 90%, such that the amount of the conductive powder and the base resin are more reasonable, thereby balancing the conductivity and uniformity of the second component.

In some embodiments of the present disclosure, the second component may further include one or more of the second solvent and the auxiliary agent, the weight content of the second solvent may be in a range of 0 to10%, and the weight content of the auxiliary agent may be in a range of 0 to 5%.

For example, the weight content of the base resin in the second component is 10%, 15%, 20%, 25%, 30%, 35% or 40%. The weight content of the conductive powder in the second component is 20%, 30%, 40%, 50%, 60%, 70%, 80% or 90%. The weight content of the second solvent in the second component is 0%, 1.0%, 2.0%, 3.0%, 4.0%, 5.0%, 6.0%, 7.0%, 8.0%, 9% or 10%. The weight content of the auxiliary agent in the second component is 0%, 1.0%, 2.0%, 3.0%, 4.0% or 5.0%.

In some embodiments of the present disclosure, the base resin in the second component is one or more of polyester resin, polyurethane resin, polyacrylic resin, vinyl chloride-vinyl acetate resin, epoxy resin, epoxy acrylic resin, epoxy acrylate resin, polyester acrylate resin, phenolic resin, nitrocellulose, ethyl cellulose, alkyd resin or amino resin.

In some embodiments of the present disclosure, the conductive powder in the second component includes one or more of silver powder, copper powder, carbon black, graphite, graphene, carbon nanotube, silver-coated copper powder, iron powder, or iron-nickel powder. When the conductive powder in the second component includes silver powder, the silver powder may be flake silver powder, spherical silver powder, rod-shaped silver powder, needle-shaped silver powder, or dendritic silver powder.

In some embodiments of the present disclosure, the auxiliary agent in the second component includes one or more of a dispersant, a wetting agent, and a deformer. The dispersant may include one or more of an anionic surfactant, a nonionic surfactant and a polymer surfactant.

In some embodiments of the present disclosure, the second solvent in the second component is one or more of water, ethyl acetate, butyl acetate, isoamyl acetate, n-butyl glycolate, petroleum ether, acetone, butanone , cyclohexanone, methyl isobutyl ketone, diisobutyl ketone, toluene, xylene, butyl carbitol, alcohol ester 12, DBE, ethylene glycol butyl ether, ethylene glycol ethyl ether, dipropylene glycol methyl ether, n-hexane, cyclohexane, n-heptane, n-octane, or isooctane.

It should be noted that the coating material in the first component can be the same with the base resin in the second component or different from the base resin in the second component. The first solvent in the first component can be same as the second solvent in the second component or different the second solvent in the second component. A person skilled in the art can select according to the actual requirements.

In some embodiments of the present disclosure, if the content of the first component is excessively high and the content of the second component is excessively low in the conductive material, the electrical property of the conductive material will be lower. If the content of the first component is excessively low, and the content of the second component is excessively high, the flexibility of the conductive material after being cured will be unsatisfactory. Based on this, in some embodiments of the present disclosure, the weight ratio of the first component to the second component in the conductive material is in a range of 10:1 to 1:9, e.g., 10:1, 9:1, 8:1, 7:1, 6:1, 5:1, 4:1, 3:1, 2:1, 3:2, 1:1 2:3, 1:2, 2:5, 1:3, 1:4, 1:5, 1:6, 1:7, 1:8 or 1:9.

The conductive material in some embodiments of the present disclosure may further include a viscosity modifier. After the first component and the second component are mixed, the viscosity of the conductive material can be adjusted by the viscosity modifier according to actual requirements. The viscosity modifier can be one or more of ethyl acetate, petroleum ether, acetone, xylene, butyl carbitol, alcohol ester 12, and DBE (dibasic ester).

In addition, a second aspect of the present disclosure provides an electronic device. The electronic device includes a wire. The wire is made of any of the conductive materials described above. The electronic device can be any electronic devices that require wires, e.g., a flexible sensor, a wearable device, a flexible electronic tag, a FPC (Flexible Printed Circuit) board, and especially an electronic device that require the flexible wire.

In addition, a third aspect of the present disclosure provides a method for manufacturing a conductive material, which is used to manufacture the conductive materials described above. As shown in FIG. 3, FIG. 3 is a flowchart of a method for manufacturing a conductive material according to an embodiment of the present disclosure. In some embodiments of the present disclosure, the method for manufacturing the conductive material includes following steps.

S1, a first component is manufactured. The first component includes a liquid metal with a melting point below room temperature, a coating material coating a liquid metal droplet formed by the liquid metal, and a first solvent.

S2, a second component is manufactured. The second component includes a base resin and a conductive powder.

S3, the first component and the second component are weighed in proportion, and the first component and the second component are mixed uniformly to obtain the conductive material.

In some embodiments of the present disclosure, the S1 includes the following steps.

S11, the coating material is dissolved with the first solvent so as to form a coating material solution.

S12, the coating material solution and the liquid metal are weighed in proportion, and the coating material solution and the liquid metal are put into a closed container.

S13, a protective gas is filled to mix.

The protective gas serves to prevent excessive oxidation of the liquid metal, avoid the decrease of the conductivity of the liquid metal and the increase of the viscosity.

In some embodiments of the present disclosure, the above mixing method may be mechanical stirring, ultrasound, or a combination thereof.

S14: obtaining the first component after the mixing is completed.

After the mixing is completed, vacuum degassing can also be carried out to improve the performance of the prepared first component.

In some embodiments of the present disclosure, when the second component further includes a second solvent and an auxiliary agent, the S2 includes following steps.

S21, the base resin is dissolved into a resin solution with the second solvent.

S22, the resin solution and the auxiliary agent are weighed in proportion, and the auxiliary agent is added to the resin solution.

S23, the conductive powder is weighed, and is put into a closed container together with the material obtained in S22.

S24, the material obtained in S23 is pre-dispersed with a mixer.

S25, the material obtained in S24 is processed with a three-axis rolling mill; the S25 can also be replaced by using a horizontal sand mill for sanding.

S26, the material obtained in S25 is defoamed to obtain the second component.

In some embodiments of the present disclosure, S3 includes following steps.

S31, the first component and the second component are weighed in proportion, and the first component and the second component are added to a container.

S32, the first component and the second component are stirred uniformly.

S33, a viscosity of the material obtained from S32 is measured to compare the viscosity with a preset viscosity range. If the viscosity is within the preset viscosity range, the material obtained from S33 is the conductive material. If the viscosity is higher than the preset viscosity range, S34 will be performed.

S34, a viscosity modifier is added to adjust the viscosity of the material obtained from S32 to be within the preset viscosity range, so as to obtain the conductive material.

The above preset viscosity range needs to be selected according to the corresponding process when the conductive material is used. For example, when a screen printing process is adopted, the above preset viscosity range can be 2000 to 6000 cp.

In order to facilitate understanding and implementation of a person skilled in the art, some examples are provided as follows for description.

### Example 1

First component:

| Composition | Type | Dosage (g) |
|---|---|---|
| Liquid metal | Gallium indium | 100 |
| | eutectic alloy | |
| Coating material | Polyester resin | 2 |
| First solvent | Ethylene glycol butyl | 8 |
| | ether acetate | |
| Deformer | Silicone deformer | 0.2 |

Second component:

| Composition | Type | Dosage (g) |
|---|---|---|
| Base resin | Polyester resin | 20 |
| Conductive powder | Flake silver powder | 80 |
| Dispersant | Polymer dispersant | 3 |

Conductive material:

| | dosage | Adding |
|---|---|---|
| Component name | (g) | ratio (%) |
| First component | 20 | 28.5% |
| Second component | 50 | 71.5% |

The conductive material has a viscosity of 3300 cp, and is thermally cross-linked at 120° C. after screen printing. The printed pattern has a square resistance of 9 mΩ (25.4 μm).

### Example 2

The first component and the second component of Example 2 are the same with that of Example 1.

Conductive material:

| | dosage | Adding |
|---|---|---|
| Component name | (g) | ratio (%) |
| First component | 50 | 50% |
| Second component | 50 | 50% |

The conductive material has a viscosity of 7100 cp, and the printed pattern has a square resistance of 17 mΩ (25.4 μm).

### Example 3

The first component and the second component of Example 3 are the same with that of Example 1.

Conductive material:

| | dosage | Adding |
|---|---|---|
| Component name | (g) | ratio (%) |
| First component | 48 | 48% |
| Second component | 48 | 48% |
| Viscosity modifier | 4 | 4 |

The viscosity modifier is petroleum ether.

The conductive material has a viscosity of 2700 cp, and the printed pattern has a square resistance of 16.8 mΩ (25.4 μm).

### Example 4

First component:

| Composition | Type | Dosage (g) |
|---|---|---|
| Liquid metal | Gallium indium tin | 200 |
| | eutectic alloy | |
| Coating material 1 | Chlorine vinegar resin | 3 |
| Coating material 2 | Silicone resin | 0.6 |
| First solvent | Cyclohexanone | 7 |

Second component:

| Composition | Type | Dosage (g) |
|---|---|---|
| Base resin | Chlorine vinegar resin | 20 |
| Conductive powder | Flake silver powder | 100 |
| Dispersant | Polymer dispersant | 8 |
| Second solvent | DBE (dibasic ester) | 2 |

Conductive material:

| | dosage | Adding |
|---|---|---|
| Component name | (g) | ratio |
| First component | 10 | 15.6% |
| Second component | 50 | 78.2% |
| Viscosity modifier | 4 | 6.2% |

The viscosity modifier is DBE (dibasic ester).

The conductive material has a viscosity of 4000 cp, and the printed pattern has a square resistance of 3.7 mΩ (25.4 μm).

### Example 5

The first component of Example 5 is the same with that of Example 4.

Second component:

| Composition | Type | Dosage (g) |
|---|---|---|
| Base resin | Acrylic resin | 20 |
| Conductive powder | Flake silver powder | 100 |
| Dispersant | Polymer dispersant | 8 |
| Second Solvent | DBE (dibasic ester) | 2 |

Conductive material:

| Component name | dosage (g) | Adding ratio |
|---|---|---|
| First component | 10 | 15.6% |
| Second component | 50 | 78.2% |
| Viscosity modifier | 4 | 6.2% |

The viscosity modifier is DBE (dibasic ester).

The conductive material has a viscosity of 4600 cp, and the printed pattern has a square resistance of 3.1 mΩ (25.4 μm).

### Example 6

First component:

| Composition | Type | Dosage (g) |
|---|---|---|
| Liquid metal | gallium indium tin | 100 |
| | eutectic alloy | |
| Coating material | Sodium alginate | 2 |
| First solvent | Water | 8 |

Second component:

| Composition | Type | Dosage (g) |
|---|---|---|
| Base resin | Acrylic resin | 20 |
| Conductive powder | Spherical silver powder | 120 |
| Dispersant | Polymer dispersant | 4 |

Conductive material:

| Component name | dosage (g) | Adding ratio |
|---|---|---|
| First component | 50 | 50% |
| Second component | 50 | 50% |

The conductive material has a viscosity of 5500 cp, and the printed pattern has a square resistance of 40 mΩ (25.4 μm).

### Comparative Example 1

Compared with Example 2, Comparative example 1 only contains liquid metal in the first component, that is, the liquid metal was mixed after other materials were mixed, and the rest is the same.

First component

| Composition | Type | Dosage (g) |
|---|---|---|
| Liquid metal | Gallium indium | 100 |
| | eutectic alloy | |

Second component

| Composition | Type | Dosage (g) |
|---|---|---|
| Base resin | Polyester resin | 20 |
| Conductive powder | Flake silver powder | 80 |
| Dispersant | Polymer dispersant | 3 |

Conductive material:

| Component name | dosage (g) | Adding ratio (%) |
|---|---|---|
| First component | 50 | 50% |
| Second component | 50 | 50% |

In Comparative example 1, the new first component and second component are difficult to mix and cannot form a uniform material. The printed pattern has obvious liquid metal droplets oozing out, and has a square resistance of 202 mΩ (25.4 μm).

### Comparative Example 2

Compared with Example 2, Comparative example 2 does not adopt the method of manufacturing two components separately then to compound the two components. In Comparative example 2, the materials of the two components converted at a weight ratio of 1:1 were added to the same container together, and were compounded by means of ultrasound and stirring.

Conductive material:

| Composition | Type | Dosage (g) |
|---|---|---|
| Liquid metal | gallium indium | 45.46 |
| Resin material | Polyester resin | 4.54 |
| (corresponding to the original | | |
| first component to fill) | | |
| Resin material | Polyester resin | 9.7 |
| (corresponding to the original | | |
| second component to fill) | | |
| Conductive powder | Flake silver | 38.83 |
| | powder | |
| Dispersant | Polymer | 1.46 |
| | dispersant | |

After the materials of Comparative example 2 were processed by ultrasound and stirred for 10 minutes, gray-black precipitation was produced, which could not form a uniform material, and the resistance of the printed pattern was infinite.

### Comparative Example 3

The adding amount of materials of comparative Example 3 is the same with that of Comparative example 2. Compared with Comparative example 2, Comparative example 3 only changes the processing method to stirring and mixing, in which the stirring speed was 500 r/min and the materials cannot be mixed evenly for 20 minutes. When the stirring speed was accelerated to 1000 r/min, gray-black precipitation is also produced and a uniform material cannot be formed, and the resistance of the printed pattern was infinite.

Compared with Example 2, the first component of Comparative example 4 is composed of liquid metal and a first solvent with a high boiling point, and the rest is the same.

First component:

| Composition | Type | Dosage (g) |
|---|---|---|
| Liquid metal | Gallium indium | 100 |
| | eutectic alloy | |
| First solvent | Alcohol ester 12 | 10 |

Second component:

| Composition | Type | Dosage (g) |
|---|---|---|
| Base resin | Polyester resin | 20 |
| Conductive powder | Flake silver powder | 80 |
| Dispersant | Polymer dispersant | 3 |

Conductive material:

| Component name | dosage (g) | Adding ratio (%) |
|---|---|---|
| First component | 50 | 50% |
| Second component | 50 | 50% |

In Comparative example 4, the liquid metal pre-dispersed material in the new first component has a larger particle size. After the new first component was mixed with the second component, the printed pattern has obvious liquid metal droplets oozing out, and has a square resistance of 172 mΩ (25.4 μm).

### Comparative Example 5

Comparing with Comparative example 4, the first solvent of Comparative example 5 is changed to petroleum ether, and the rest is the same. In Comparative example 5, gray-black precipitation was produced after the new first component was mixed with the second component, which could not form a uniform material, and the resistance of the printed pattern was infinite.

Finally, it should be noted that the technical solutions of the present disclosure are illustrated by the above embodiments, but not intended to limit thereto. Although the present disclosure has been described in detail with reference to the foregoing embodiments, a person skilled in the art can understand that the present disclosure is not limited to the specific embodiments described herein, and can make various obvious modifications, readjustments, and substitutions without departing from the scope of the present disclosure.

1. A conductive material, comprising:
a first component, comprising a liquid metal with a melting point below room temperature, a coating material coating a liquid metal droplet formed by the liquid metal, and a first solvent; and
a second component, comprising a base resin and a conductive powder;
wherein the first component and the second component are weighed in proportion and uniformly mixed to obtain the conductive material.

2. The conductive material according to claim 1, wherein the first component comprises 30% to 99% by weight of the liquid metal, 0.1% to 30% by weight of the coating material, and 0.9% to 50% by weight of the first solvent.

3. The conductive material according to claim 2, wherein the first component comprises 75% to 99% by weight of the liquid metal, 1% to 5% by weight of the coating material, and 3% to 20% by weight of the first solvent.

4. The conductive material according to claim 2, wherein a weight ratio of the first solvent to the coating material is in a range of 1:2 to 1:5.

5. The conductive material according to claim 1, wherein the liquid metal comprises at least one of gallium, gallium indium alloy, gallium tin alloy, gallium indium tin alloy, or gallium indium tin zinc alloy.

6. The conductive material according to claim 1, wherein the liquid metal droplet has a diameter ranging from 0.01 μm to 100 μm.

7. The conductive material according to claim 6, wherein the liquid metal droplet has a diameter ranging from 0.05 μm to 10 μm.

8. The conductive material according to claim 1, wherein the coating material comprises one or more of polyester resin, melamine resin, chlorine vinegar resin, vinyl chloride-vinyl acetate resin, silicone resin, gelatin, sodium alginate, polyvinyl pyrrolidone, chitosan, polyurethane resin, polyacrylic resin, vinyl chloride-vinyl acetate resin, epoxy resin, fluorocarbon resin, epoxy acrylic resin, epoxy acrylate resin, polyester acrylate resin, phenolic resin, nitrocellulose, ethyl cellulose, alkyd resin, or amino resin.

9. The conductive material according to claim 1, wherein the first solvent comprises one or more of water, ethyl acetate, butyl acetate, isoamyl acetate, n-butyl glycolate, petroleum ether, acetone, butanone , cyclohexanone, methyl isobutyl ketone, diisobutyl ketone, toluene, xylene, butyl carbitol, alcohol ester 12, dibasic ester, ethylene glycol butyl ether, ethylene glycol ethyl ether, dipropylene glycol methyl ether, n-hexane, cyclohexane, n-heptane, n-octane, or isooctane.

10. The conductive material according to any one of claim 1, wherein the first component further comprises a deformer.

11. The conductive material according to claim 1, wherein in the second component, a weight content of the base resin is in a range of 10% to 40%, and a weight content of the conductive powder is in a range of 20% to 90%.

12. The conductive material according to claim 1, wherein the second component further comprises one or more of a second solvent or an auxiliary agent.

13. The conductive material according to claim 1, wherein the base resin comprises one or more of polyester resin, polyurethane resin, polyacrylic resin, vinyl chloride-vinyl acetate resin, epoxy resin, epoxy acrylic resin, epoxy acrylate resin, polyester acrylate resin, phenolic resin, nitrocellulose, ethyl cellulose, alkyd resin or amino resin.

14. The conductive material according to claim 1, wherein the conductive powder comprises one or more of silver powder, copper powder, carbon black, graphite, graphene, carbon nanotube, silver-coated copper powder, iron powder, or iron-nickel powder.

15. The conductive material according to claim 1, wherein the weight ratio of the first component to the second component is in a range of 10:1 to 1:9.

16. The conductive material according to claim 1, further comprising a viscosity modifier added after the first component and the second component are mixed.

17. A method for manufacturing the conductive material according to claim 1, comprising:
S1: manufacturing the first component, wherein the first component comprises a liquid metal with a melting point below room temperature, a coating material coating a liquid metal droplet formed by the liquid metal, and a first solvent;
S2: manufacturing the second component, wherein the second component comprises a base resin and a conductive powder; and
S3: weighing in proportion and mixing uniformly the first component and the second component to obtain the conductive material.

18. The method for manufacturing the conductive material according to claim 17, wherein the S1 comprises:
S11: dissolving the coating material with the first solvent so as to form a coating material solution;
S12: weighing in proportion and putting the coating material solution and the liquid metal into a closed container;
S13: filling a protective gas and mixing the coating material solution and the liquid metal; and
S14: obtaining the first component after the mixing is completed.

19. The method for manufacturing the conductive material according to claim 17, wherein the S3 comprises:
S31: weighing in proportion and adding the first component and the second component to a container;
S32: stirring the first component and the second component uniformly to obtain a mixture;
S33: measuring a viscosity of the mixture obtained from S32 to compare the viscosity with a preset viscosity range, wherein if the viscosity is within the preset viscosity range, the mixture obtained from S33 is the conductive material, and if the viscosity is higher than the preset viscosity range, S34 will be performed; and
S34: adding a viscosity modifier to adjust the viscosity of the mixture obtained from S32 to be within the preset viscosity range, so as to obtain the conductive material.

20. An electronic device, comprising a wire, wherein the wire is made of the conductive material according to claim 1.
